(19) United States
(12) Patent Application Publication
(10) Pub. No.: US 2008/0046879 A1
(43) Pub. Date: Feb. 21, 2008

(54) NETWORK DEVICE HAVING SELECTED FUNCTIONALITY

(76) Inventors: Michael Hostetler, Lakewood, CO (US); Kevin Fries, Lakewood, CO (US); Brian Gregory Krewson, Colorado Spring, CO (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/838,936

(22) Filed: Aug. 15, 2007

Related U.S. Application Data
(60) Provisional application No. 60/837,767, filed on Aug. 15, 2006.

(51) Int. Cl. G06F 9/44; G06F 15/16

(52) U.S. Cl. 717/171; 709/227

(57) ABSTRACT

Certain aspects and embodiments of the present invention provide a local device capable of delivering selected functionalities without requiring users with little or no familiarity with computers or other processor-based devices to configure the local device. In some embodiments of the present invention, the local device includes a display integrated with a housing having a keyboard input that is adapted to communicate with a remote server and/or datacenter through a network. The local device can include network interface that is a telecom battery adapted to connect to the network and datacenter. The datacenter can include user data and/or functions that the user can access over the network using the local device.

### CROSS REFERENCE TO RELATED APPLICATIONS

The present application claims priority to U.S. Provisional Patent Application No. 60/837,767, titled “Network Device Having Selected Functionality,” filed Aug. 15, 2006, the entire contents of which are incorporated herein by reference.

### FIELD OF THE INVENTION

The present invention relates generally to devices for connecting to a network and specifically to devices for delivering selected functionality to device users by connecting to a network.

### BACKGROUND

The Internet provides users with a broad range of communication options. Users may obtain information from remote servers or computers, create, send, and receive e-mail, or view electronic photographs through an Internet appliance and a connection to the Internet. Examples of Internet appliances include computers, personal digital assistants, intelligent kitchen appliances, and mobile telephones. Conventional Internet appliances can include a variety of hardware and software components that allow the user to connect to the Internet or other network and perform various functions in connection with data received from the Internet or locally on the device. Generally, Internet appliances include a hard drive for storing software and other data installed, downloaded, or created by the user, a processor for executing software programs and/or other data stored in the hard drive, input devices, such as a keyboard and/or mouse, for allowing the user to input commands and manipulate data, and a display device such as a monitor. Software stored on Internet appliances can include an operating system, word processor, Internet browser, hardware drivers, and other applications for viewing and creating data such as photos and documents.

Conventional Internet appliances such as computers can provide users with a broad range of functions. The devices usually require the user to configure the software and/or hardware settings to perform certain functions, such as connecting to a particular network. Users often do not use or need most of the functions provided by the Internet appliance. For instance, users who only wish to access the Internet to send and receive email do not need software for performing other tasks, such as creating or playing movies. Furthermore, persons unfamiliar or inexperienced with the Internet, such as elderly individuals, may be less likely to use a device having several functions and hardware components. Inexperienced individuals may not need most of the functions and may not understand or appreciate the relationship the functions and components have with the individual's intended purpose. In addition, persons unfamiliar with these devices may be unable or unmotivated to configure the device properly.

Conventional Internet appliances can also include a modem or other device to send and receive data from the Internet or other network. Generally, a user utilizes Internet browser software stored locally on the Internet appliance and the modem or other device to obtain access to the Internet or other network. The user can download information and data in electronic form, such as pictures, documents, or other data, to the device's local hard drive and software on the device displays the information and data. Conventional Internet appliances sometimes experience problems caused by hardware or software components malfunctioning or becoming damaged, requiring the user to replace appliance components or the entire appliance. For instance, the Internet appliance may sustain physical damage to the hardware components or obtain an electronic virus that negatively affects software stored locally on the device. In some instances, users lose data and software stored locally on the hard drive caused by the damage. Persons unfamiliar with the Internet may be reluctant to use the device for fear they will cause the device to malfunction and they will lose their data and be unable to fix the device or otherwise configure the device to perform properly. Furthermore, conventional Internet appliances may require the user to configure the correct settings to access the network.

Accordingly, a need exists for an Internet appliance with selected functionality that is easy to use, even for those relatively unfamiliar with the Internet. A need also exists for a device that can access the Internet or other network and does not require users to configure the device to perform the selected functions or connect to the network. A need also exists for a device that stores selected user data remotely from the device to prevent the user from losing the data if the device becomes damaged or otherwise inoperable.

### SUMMARY

Certain aspects and embodiments of the present invention provide a local device capable of delivering selected functionalities without requiring users with little or no familiarity with computers or other processor-based devices to configure the local device. In some embodiments, the local device includes a display integrated with a housing having a keyboard input, processor, read only memory, cache, and a network interface. The local device may also include a web server that can communicate with a remote server and/or datacenter through a network. The network interface can be a telecom battery that connects to a network and datacenter on a personal handy-phone system (PHS) or other cellular communication system.

The datacenter may store data, such as account information and unread email messages, associated with the local device user. The local device may store static data, such as an operating system, and temporarily store, such as in a cache, data downloaded from the datacenter during a session.

In some embodiments of the present invention, the local device includes an Internet browser application that provides users with the ability to only select links displayed on a screen and not other functions associated with conventional Internet browser applications.

In some embodiments of the present invention, the local device includes a connection manager configured to establish a connection between the local device and the network. The connection manager may automatically connect to the network after the user turns on the local device without requiring the user to configure the local device or select the connection function.

In some embodiments of the present invention, the remote server and/or datacenter can automatically update software on the local device.

Various embodiments of the present invention provide a local device capable of performing selected Internet and related functions without requiring the user to configure the local device to perform these selected functions. In one embodiment, the local device includes a web server that automatically connects to a remote server and/or datacenter on a network. The web server may receive data from the datacenter and display the data and/or a menu to the user. The menu can include selected options, such as email functions, electronic photography options, and access to the Internet. The local device may also include a keyboard to provide the user with the ability to input commands. In some embodiments, the user employs arrow keys on the keyboard to navigate the menu and select a desired link. The user may also store data, such as photographs or received email messages in the datacenter.

In some embodiments, the local device can connect to the data center via at least one wireless connection and can automatically receive a software update from the datacenter.

These illustrative embodiments are mentioned not to limit or define the invention, but to provide examples to aid understanding thereof. Illustrative embodiments are discussed in the Detailed Description, and further description of the invention is provided there. Advantages offered by the various embodiments of the present invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 shows a local device in communication with a datacenter according to one embodiment of the present invention;

FIG. 2 shows a local device in communication with a datacenter through a remote server according to one embodiment of the present invention;

FIG. 3 is a block diagram illustrating the flow of data between a local device and a datacenter according to one embodiment of the present invention;

FIG. 4 is a flow chart illustrating a method of using a device to receive data from a remote server and/or datacenter according to one embodiment of the present invention;

FIG. 5 shows an Internet browser screen according to one embodiment of the present invention; and

FIG. 6 is a flow chart illustrating a method for automatically updating a local device with new or additional software applications according to one embodiment of the present invention.

### DETAILED DESCRIPTION

### Introduction

Certain aspects and embodiments of the present invention provide a simple local device capable of delivering Internet and other functionalities to individuals who may be unfamiliar or inexperienced with computers or other devices used to access a network such as the Internet. One illustrative embodiment of the present invention includes a relatively small local device having an LED based flat screen with a viewing size of approximately 10 inches that the user can flip up to use the local device and flip down when the local device is not in use. The local device includes ports to connect with a keyboard.

In one embodiment of the present invention, a system for delivering selected Internet functionality is provided. The system comprises a local device that comprises a display integrated with a device housing, a processor, a computer-readable medium comprising an operating system and a web sever, and a telecom battery. The operating system is adapted to provide selected functions to a user. The web server is adapted to communicate with a datacenter through a network. The telecom battery is adapted to automatically connect the local device to the network when the local device is turned on.

The local device can operate on a Linux open source operating system and can include a local web server, such as the Apache web server.

The local device executes software applications locally. The software applications access a limited amount of data directly from the local device, but the majority of data is stored on a central data center. The local device includes a network interface for connecting to a network, such as the Internet, to access the data center. The local device can provide a limited set of software applications to simplify the interface provided to the user. In one illustrative embodiment, the limited set of software applications includes email, photo management, and web browsing.

An advantage of certain aspects and embodiments of the present invention is to provide a system and device that is user-friendly and does not require the user to perform various configurations to communicate and/or obtain data from a network such as the Internet.

A further advantage of certain aspects and embodiments of the present invention is to provide a system and device that can store user data on a remote server or datacenter, thereby diminishing the possibility that the user will lose the data, such as in the case of a local device failure.

A still further advantage of certain aspects and embodiments of the present invention is its ability to provide a system and device that allows users such as those with limited to no experience with the Internet, to communicate with others using email and/or sharing electronic photographs.

A still further advantage of certain aspects and embodiments of the present invention is a system and device that stores selected data received from the data center in a cache located in the device to reduce the latency period of transmitting and receiving data.

This introduction is given to introduce the reader to the general subject matter of the application. By no means is the invention limited to such subject matter. Illustrative embodiments are described below.

### System Architecture

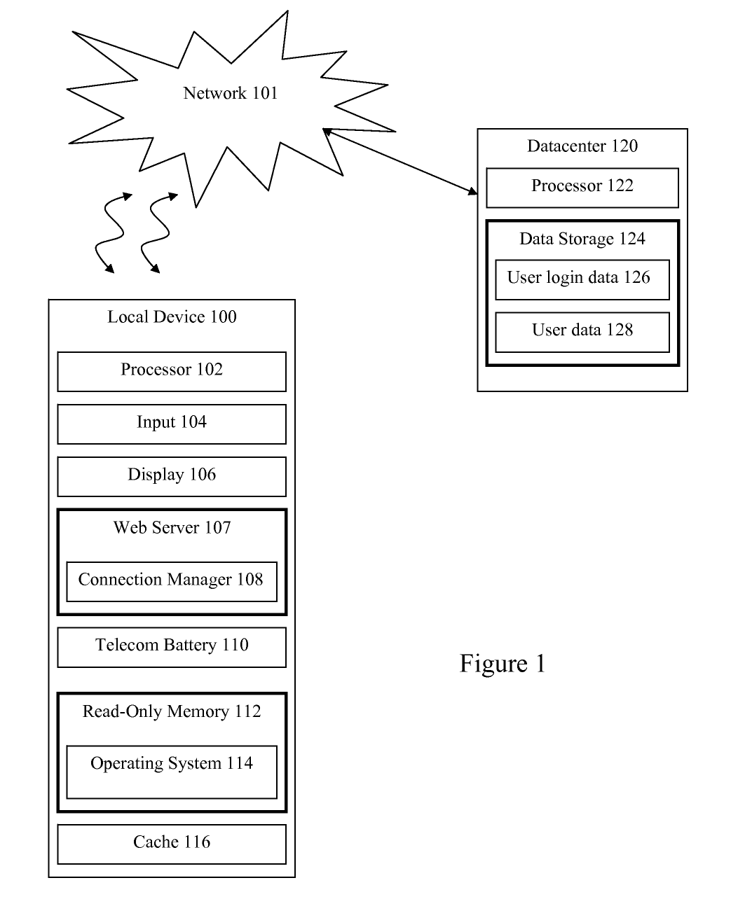

FIG. 1 illustrates one embodiment of a local device 100 in communication with a datacenter 120 through a network 101. The network 101 may be any type of telecommunications network, such as a public switched telephone network, local area network, and wide area network, or combination of two or more types of telecommunications networks. The local device 100 can connect to the network 101 wirelessly or through a wireline. The local device 100 may be a small console that includes a processor 102, an input component 104, a display 106, and a web server 107. The input component 104 may be a keyboard or display touch screen to allow a user to input commands and data. The display 106 may be a pivotal display integrated with the console. In some embodiments, the local device 100 may include several pieces of the components connected by wires instead of one integrated console.

Processors 102 used by the local device 100 can be any of a number of computer processors, such as processors from Intel Corporation of Santa Clara, Calif., Advanced Micro Devices, Inc. (“AMD”) of Sunnyvale, Calif., Motorola Corporation of Schaumburg, Ill. In some embodiments, the processors 102 may have a processing speed of 300 MHz. Such processors may include a microprocessor, an ASIC, and state machines. Such processors 102 include, or may be in communication with, a computer-readable medium, which stores program code or instructions that, when executed by the processor, cause the processor to perform actions. Embodiments of computer-readable medium include, but are not limited to, an electronic, optical, magnetic, or other storage or transmission device capable of providing a processor, such as the processor 114 of server device 104, with computer-readable instructions. Other examples of suitable computer-readable medium include, but are not limited to, a floppy disk, CD-ROM, DVD, magnetic disk, memory chip, ROM, RAM, an ASIC, a configured processor, optical media, magnetic tape media, or any other suitable medium from which a computer processor can read instructions. Also, various other forms of computer-readable mediums may transmit or carry program code or instructions to a computer, including a router, private or public network, or other transmission device or channel, both wired and wireless. The instructions may include program code from any computer-programming language, including, for example, C, C++, C#, Visual Basic, Java, Python, Perl, and JavaScript.

The web server 107 includes a connection manager 108 that can automatically initiate a connection with the network 101 when the local device 100 after a specified event occurs, such as after the local device 100 is turned on. The connection manager 108 may control a telecom battery 110 to connect the local device 100 to the network 101 and datacenter 120. For example, when a user flips a display 106 up, the web server 107 can automatically search for a network connection signal using the telecom battery 110 to establish a PHS or other network connection. The telecom battery 110 may have a PHS cellular communication system, such as a four-channel PHS card, or other wireless system to connect to the network. Once the telecom battery 110 locates a network signal, such as a signal emanating from a network interface device that is in communication with the network 101 via a public switched telephone line or otherwise, the web server 107 can initiate a connection with the network 101. The user may be prompted to input their login information to complete access to the network 101 and to any data stored on a remote server or datacenter 120, as described in more detail below.

According to one embodiment of the invention, the telecom battery 110 may be plugged into the local device 100. Used in this manner, the telecom battery 110 is analogous to an electric battery. Just as an electric battery can be plugged into an electronic device to add electricity to the device, a telecom battery may be plugged into the local device 100 to add telecommunication capability such as, for example, a PCMCIA card. The telecom battery 110 may include the necessary software, hardware, and airtime to connect to one or more carrier networks, such as network 101. These components are preferably included (prepackaged) into the telecom battery 110. For example, a telecom battery 110 may include one or more transceiver circuits that adapted to connect to a number and/or type of networks, the appropriate connection software, and prepaid airtime for one, six, twelve, or twenty four months. The telecom battery 110 can also be used to add additional telecommunication capabilities to an electronic device already having some telecommunication abilities.

The processor 102 can access a computer-readable medium, such as read-only memory 112 that includes an operating system 114 and may include other software applications and/or user static data. The local device 100 also includes a computer-readable medium, such as cache 116 for temporarily storing downloaded or other data. The cache 116 may also assist in decreasing the latency period during data transmission and allow the user to manipulate data on the local device 100. In some embodiments, the cache 116 is erased when the user turns off the local device 100 or places the local device 100 in a standby mode.

The datacenter 120 includes a processor 122 for accessing data stored in the datacenter 120 and processing commands received from the local device 100. The datacenter may also include a computer-readable medium, such as data storage 124 that includes user login data 126 and user data 128, such as photographs and emails stored by the user and/or email sent to the user's account. The datacenter 120 may also include other types of software applications, such as an access manager to regulate which users have access the datacenter and particular files stored on the datacenter. In some embodiments, the datacenter 120 may connect to the Internet or other network having third-party information and allow the local device 100 and the user to connect to the Internet or other network.

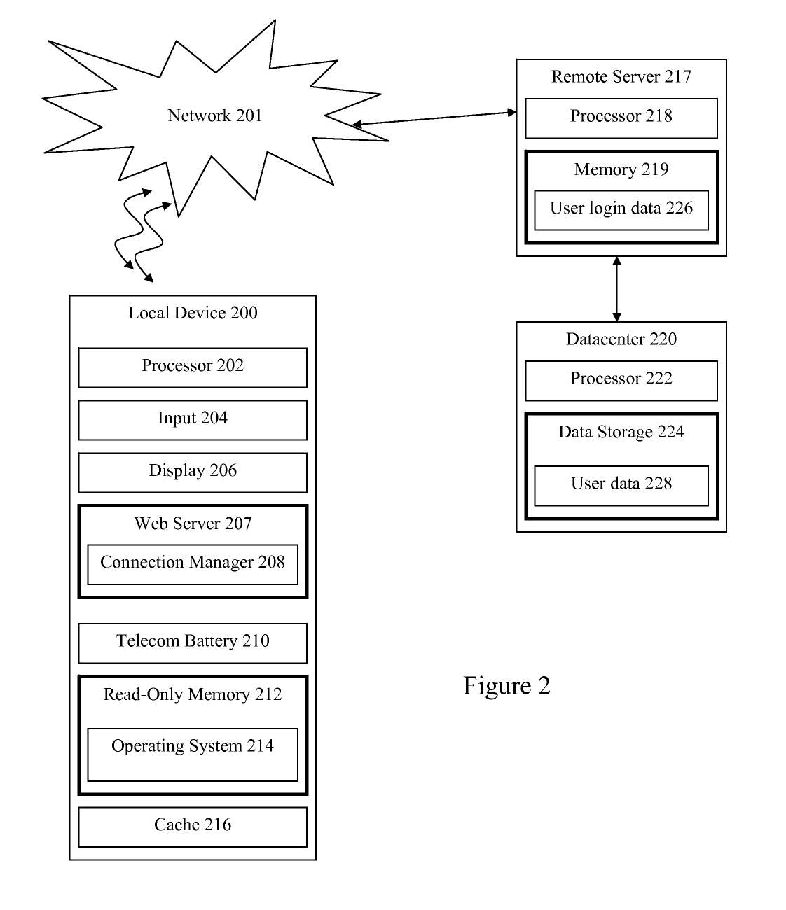

FIG. 2 shows another embodiment of a local device 200 in communication with a datacenter 220. In FIG. 2, the local device 200 uses a connection manager 212 and telecom battery 216 to connect to a remote server 217 through a network 201. The network 201 may be any type of network that can communicate with the local device 200 and the remote server 217. The remote server 217 may be a gateway between the local device 200 and the datacenter 220. For instance, the remote server 217 may include a computer-readable medium, such as memory 219 having user login data 226 that requires the user to input the correct login data into the local device 200 and communicate the login data to the remote server 217 before the remote server 217 provides access to user data 228 stored in the datacenter 220. The remote server 217 may receive login data provided by the user and compare the received data to login data 226 stored in the memory 219. If the two sets of login data match, the remote server 217 allows the local device 200 to access datacenter 220 or other networks. In some embodiments, the remote server 217 communicates with the Internet and/or third-party data to provide the user access to the Internet and/or third-party data.

### Illustrative Information Flow

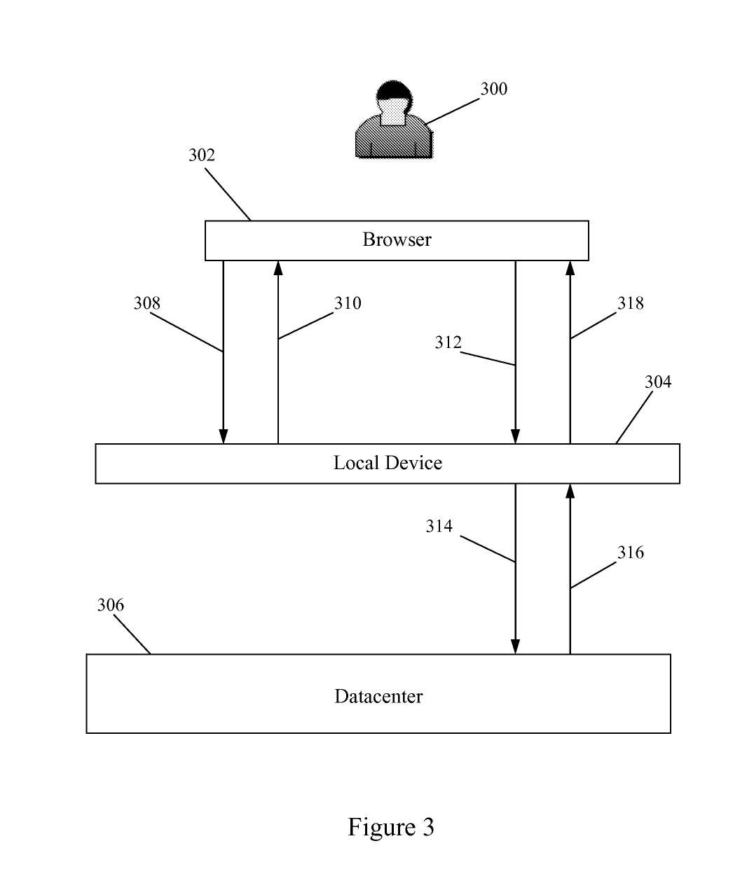

FIG. 3 is a block diagram illustrating the flow of data between a local device and a datacenter according to one embodiment of the present invention. After connecting to a network, the user 300 uses a browser 302 integrated with the local device 304 to render an interface in which the user 300 selects the desired data. When the user 300 selects data stored locally on the local device 304, the browser requests the data 308 from the local device 304. Data stored on the local device 304 may include photographs and previously read emails uploaded by the user or downloaded from the datacenter during the session and stored temporarily on the local device 304. The local device 304 locates the requested data and sends the data 310 to the browser 302 for display.

The user 300 can access data located in the datacenter 306 by using the browser 302 to send a request for remote data 312 to the local device 304. The local device 304 can include a web server that communicates the request 314 to the datacenter 306 through a network. The datacenter 308 receives the request, locates the requested data, and returns the requested data 316 to the local device 304. The local device 304 receives the requested data and determines how to display the data. In some embodiments, the local device 304 displays the data by sending it 318 to the browser 302. For example, when the user selects a menu option, such as email, the local device 304 may request data associated with email and the particular user from the datacenter 308 and search for similar data stored locally on the local device 304. The datacenter 308 can transmit the requested data to the local device 304 through a network.

The location of the stored data is transparent to the user 300. The user may simultaneously select data from both the local device 304 and the datacenter 306 without any knowledge as to where data is coming from.

In some embodiments, the local device 304 may allow the user to store and/or upload photographs to the datacenter 306, such as by using a USB port to load the pictures on the local device and transfer them to the datacenter 306 via the network connection. The local device 304 may also allow the user to organize and/or delete the photographs.

### Using the Local Device

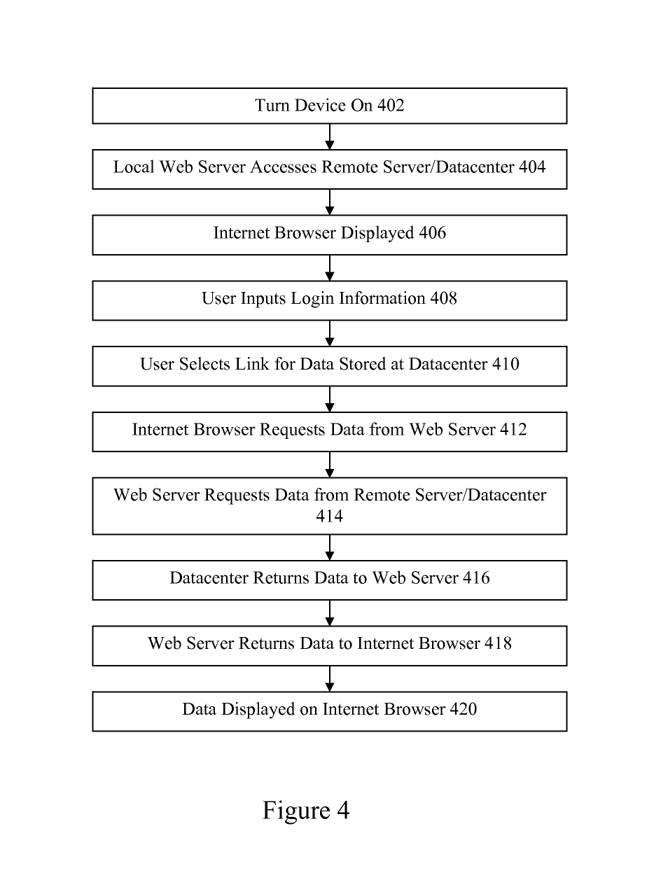

FIG. 4 is a flow chart illustrating a method of using a device to receive data from a remote server and/or datacenter according to one embodiment of the present invention. In step 402, the user turns the local device on by, for example, using a switch or lifting the display from a closed position. When the local device initializes, it loads software applications from local storage. The local device then displays an interface to the user.

The local device can include a web server that, in step 404, utilizes the telecom battery to automatically access the remote server and/or datacenter. Once the local device accesses the remote server and/or datacenter, the local device is capable of authorizing a user, downloading applications, and accessing data.

During or after connecting to the remote sever and/or datacenter, the local device displays an Internet browser to the user in step 406. The Internet browser may display a prompt for the user to input login information that is unique to the individual. Applications may also be presented that do not require the user to log in to the remote server and/or data center. For instance, if the user has photographs cached on the local machine, the user may access the photographs without accessing the datacenter.

In step 408, the user inputs login information that is transmitted to the remote server and/or datacenter and compared to user login information stored at the remote server and/or datacenter. If the login information does not match the login information stored at the remote server and/or datacenter, or if the user's account is at or below a pre-set threshold level of paid network connect time, the remote server and/or datacenter may send a prompt to the local device requesting the user to input their login information again or notifying them that they are not authorized to access the system. In one embodiment, the user utilizes a pre-paid access method. In such a method, the user pays a certain amount for a certain period of network connect time. In such an embodiment, the remote server and/or datacenter may send a prompt to the user, indicating that the amount of paid network connect time is at or below a pre-set threshold. In such a case, the user may be able to add time to the pre-paid card or provide a method of payment to continue access to the system.

After inputting the correct login information, the user, in step 410, selects a link on the Internet browser to request data, such as unread emails, photographs, or otherwise, stored at the datacenter. In some embodiments, the Internet browser displays relatively simple menu options to the user, such as email, photo sharing, and general information retrieval functions. Additional functions may include Internet browsing capabilities and access to online shopping portals. The Internet browser may limit the display provided to the user to only menus, eliminating other buttons or selections typically available within Internet browsers.

In step 412, the Internet browser then requests the selected data from a web server on the local device. In some embodiments, the web server can search a cache or other temporary memory on the local device to determine whether the memory contains the requested data before sending a request to the datacenter.

In step 414, the web server requests the data from the remote server and/or datacenter through the network, and the datacenter locates the requested data. The remote server and/or datacenter may validate the user login information again to provide additional access security and ensure the remote server and/or datacenter searches and returns the user's data.

After locating the requested data, the datacenter sends the data to the web server through the network in step 416. The network may comprise one or more networks such as a public switch telephone network, local area network, wide area network, wireless wide area network, and a PHS network.

The web server, in step 418, sends the requested data to the Internet browser for display to the user. In some embodiments, the web server may send the data over the local device's internal wirelines or other components. For instance, the web server may send the data to the processor of the local device and the processor sends the data to the Internet browser for display and to a cache for temporary storage.

In step 420 the requested data is displayed in the Internet browser. In some embodiments, the local device may display the requested data with other software applications. The Internet browser may also display the requested data in a relatively simple manner without extraneous functional options and/or information. For example, if the user requests data related to email, the Internet browser may display email functions and data in a manner understandable by people having no experience with email but having experience in sending and receiving letters through the U.S. Postal Service.

### User Interface

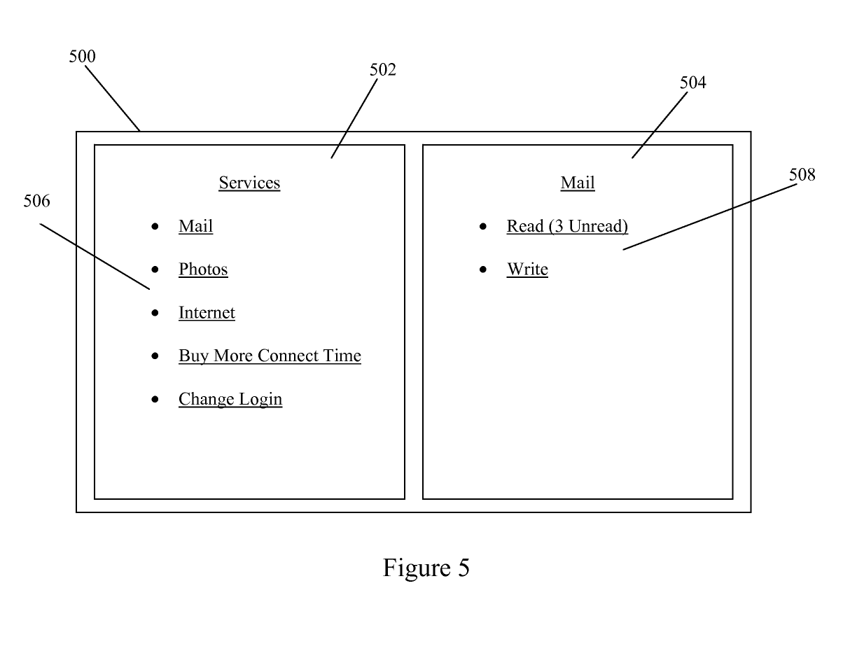

FIG. 5 illustrates an Internet browser displayed to the user according to one embodiment of the invention. The display 500 includes two frames 502, 504 to, in some embodiments, simplify the user's navigation between different data screens. The local device, on one frame 502, lists services 506 available to the user. The services may include email, photograph management, access to the Internet, ability to purchase additional network connect time, ability to change user login information, or any other service. In one embodiment, the display is written in HyperText Markup Language (HTML) and the list of services 506 include hypertext links corresponding to the location of the particular service screen. For example, a user may use arrow keys on a keyboard attached to the local device to move a cursor up, down, left, and right on the display 500 to highlight the service 506 the user wishes to employ. Once the desired service is highlighted, the user may depress another key on the keyboard to select the particular service. In some embodiments, a mouse or touch screen are provided to allow the user to select a listed service. The browser then sends a request to a web server on the local device for the requested data. The web server may search for the requested data on the local device's temporary storage and/or request the data from the datacenter.

After the user selects the desired service and the web server returns the requested service from the local device memory or datacenter, the display 500 may then show the selected service options 508 in the second frame 504. The service options 508 may also include hypertext links corresponding to the location of the particular service option. For instance, after the user selects the mail service 508, the mail options 510 appear on the second frame. The user can move a cursor in the second frame 504 using the keyboard arrow keys to highlight a desired option in the service option list 508 and depress another key to select the desired option. Once the user selects the desired service option, the requested information may appear in frame 504 or the local device and/or datacenter may provide another menu in frame 504. The frames 502, 502 may also provide a hypertext link to allow the user to go back to a screen previously viewed or otherwise.

### Updating Software on the Local Device

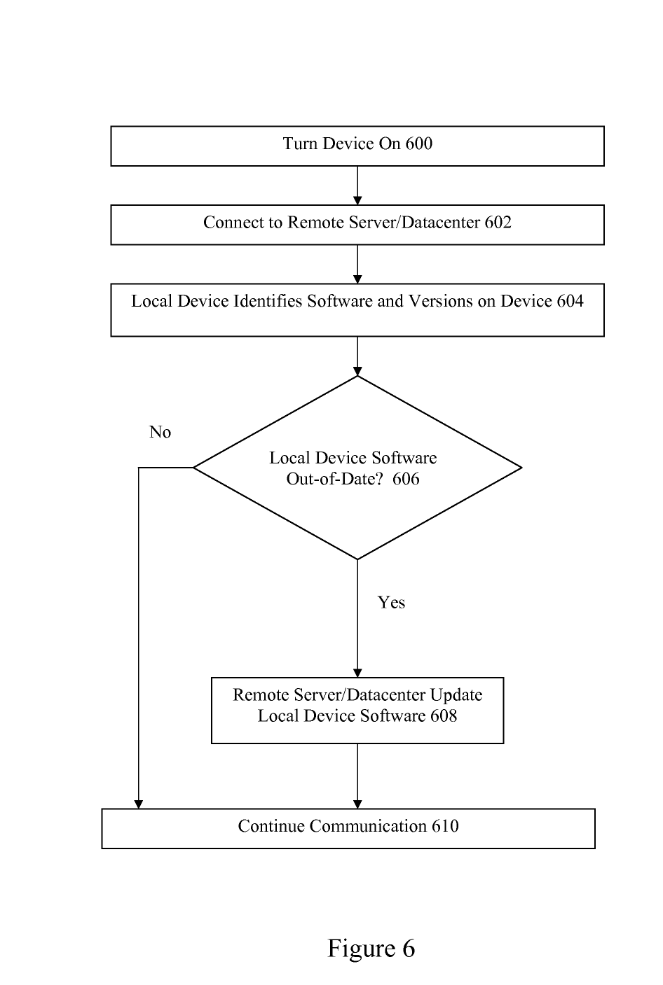

FIG. 6 illustrates one method of updating a local device with additional or new versions of software. The method begins at step 600 with a user turning the local device on by, for example, pressing a switch or lifting the display from a closed position. When the user turns on the local device, the local web server and network connection device, such as a telecom battery, may search for a network connection interface signal.

In step 602, the local device automatically connects to a remote server and/or datacenter. For instance, when the local web server and network connection device detect a network connection interface signal, they may establish a link between the local device and the network connection interface. The network connection interface may be in communication with one or more networks and a remote server and/or local device.

The local device then identifies the software and software versions currently on the device in step 604. In some embodiments, the remote server and/or datacenter can transmit a query to the local device requesting a list of the software applications and versions currently loaded on the device, and the local device answers the query by transmitting an identification of the software and versions. In other embodiments, the local device, upon linking with the network connection interface, transmits an identifier of the software currently loaded on the local device.

In step 606, the remote server and/or datacenter then determines whether the software applications and versions currently loaded on the local device are out-of-date. For instance, the remote server and/or datacenter managers may load additional software or newer versions of local device software on the remote server and/or datacenter and include installation software on the remote server and/or datacenter to automatically install the additional software or new versions in local devices upon the local device connecting to the remote server and/or datacenter.

If the software applications and versions loaded on the local device are out-of-date, the remote server and/or datacenter update the local device software in step 608. For instance, the installation software located on the remote server and/or datacenter may transmit the software updates to the local device along with commands to install the updates and/or replace existing software on the local device. In some embodiments, the user may continue to use the device to perform the selected functions while the remote server and/or datacenter updates the local device.

In step 610, the remote server and/or datacenter resumes normal communication with the local device during and/or after the local device is updated. During transmission of the software updates from the remote server and/or datacenter to the local device, the normal operation and network communication of the local device may be slowed slightly. However, the user may perform most, if not all, of the functions normally associated with the local device. If the remote server and/or datacenter determines the local device software does not need updating, the local device and remote server and/or datacenter resume normal communication in step 610.

### General

The foregoing description of the embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of this invention.

What is claimed is:

1. A system for delivering selected Internet functionality, the system comprising:
a local device comprising:
a display integrated with a device housing;
a processor;
a computer-readable medium comprising an operating system and a web server, the operating system being adapted to provide selected functions to a user, the web server being adapted to communicate with a datacenter through a network, and
a telecom battery adapted to automatically connect the local device to the network when the local device is turned on.

2. The system of claim 1, wherein the web server is adapted to display a menu to the user, the menu comprising a list of selected functions.

3. The system of claim 2, wherein the selected functions comprise:
electronic mail;
stored photograph access;
Internet access; and
network account management.

4. The system of claim 1, further comprising:
a remote server adapted to provide a gateway between the datacenter and network, the remote server comprising user login data and is adapted to receive user login information from the local device and allow the local device to access the input data stored in the data storage if the user login information matches the user login data.

5. The system of claim 1, wherein the datacenter is adapted to detect software stored on the local device and automatically update the software stored on the local device.

6. The system of claim 5, wherein the datacenter is adapted to determine if the software stored on the local device is out-of-date and update the software stored on the local device if it is out-of-date.

7. The system of claim 1, wherein the web server displays an Internet browser on the display, the Internet browser comprising a first frame and a second frame, the first frame comprising a plurality of links providing the user with access to the selected functions, the second frame being adapted to display a function selected by the user.

8. A method for delivering selected Internet functionality, the method comprising:
providing a local device adapted to connect to a datacenter;
automatically connecting the local device to the datacenter through a network using a telecom battery when the local device is turned on;
displaying a network browser;
receiving user login information;
validating the user login information;
displaying links on the network browser, each link associated with a selected function;
receiving a user selection of a link; and
displaying the selected function on the network browser.

9. The method of claim 8, further comprising:
requesting data from the datacenter;
receiving the requested data from the datacenter; and
displaying the received data on the network browser.

10. The method of claim 9, further comprising:
storing the received data in the local device.

11. The method of claim 8, wherein the network browser is an Internet browser comprising a first frame and a second frame.

12. The method of claim 8, further comprising:
receiving user login information at a remote server;
validating the user login information at the remote server; and
providing access to the datacenter if the user login information is validated.

13. The method of claim 8, further comprising:
receiving information regarding software stored on the local device; and
updating the software on the local device automatically through the network.

14. The method of claim 13, wherein receiving information regarding software stored on the local device comprises:
receiving a software version of the software stored on the local device.

15. The method of claim 14, further comprising:
determining if the software version of the software stored on the local device is out-of-date; and
automatically updating the software stored on the local device if the software version of the software stored on the local device is out-of-date.

16. The method of claim 12, wherein receiving information regarding software stored on the local device comprises:
receiving an identification of software stored on the local device.

17. The method of claim 16, further comprising:
determining if additional software is available that is not stored on the local device; and
automatically installing and storing the additional software on the local device.

18. A method for automatically updating software stored on a local device, the method comprising:
receiving an identification of stored software on the local device through a network;
receiving a version of the stored software on the local device through the network;
determining if additional software is available that is not stored on the local device;
determining if the version of the stored software on the local device is out-of-date;
automatically storing and installing available additional software if it is not stored on the local device, wherein the additional software is automatically stored and installed through the network; and
automatically updating the version of the stored software on the local device if the stored software is out-of-date, wherein the version of the stored software is automatically updated by automatically storing and installing an updated version of the software on the local device through the network.

19. The method of claim 18, wherein the additional software is automatically stored and installed without disrupting local device functionality.

20. The method of claim 18, wherein the version of the stored software is automatically updated without disrupting local device functionality.
